(19) United States
(12) Patent Application Publication
(10) Pub. No.: US 2018/0077765 A1
(43) Pub. Date: Mar. 15, 2018

(54) Lighting System For AM Transmission Towers

(71) Applicant: RVA Lighting & Masts Inc., Toronto (CA)

(72) Inventor: Brian Gray, Toronto (CA)

(21) Appl. No.: 15/701,915

(22) Filed: Sep. 12, 2017

Related U.S. Application Data
(60) Provisional application No. 62/393,702, filed on Sep. 13, 2016.
(60) Provisional application No. 62/484,458, filed on Apr. 12, 2017.
(60) Provisional application No. 62/532,396, filed on Jul. 14, 2017.

(51) Int. Cl. H05B 33/08; H05B 37/02; B64D 45/08

(52) U.S. Cl. CPC H05B 33/0842; H01Q 1/06; B64D 45/08; H05B 37/0218

(57) ABSTRACT

The system is for use with an AM transmission tower and comprises: a LED light mounted in use on the tower; a photocell; a LED beacon mounted in use on the tower; a controller; an RF choke interposed between and operatively coupling the beacon and the controller; and an RF choke interposed between and operatively coupling the photocell and the controller.

### RELATED APPLICATION DATA

This application claims the benefit of the priority of the following U.S. Provisional Patent Applications:
Ser. No. 62/393,702, filed Sep. 13, 2016;
Ser. No. 62/484,458, filed Apr. 12, 2017; and
Ser. No. 62/532,396, filed Jul. 14, 2017,
each of which is incorporated by reference herein in its entirety.

### FIELD OF THE INVENTION

The invention relates to the field of lighting systems for AM transmission towers.

### BACKGROUND

Operators of towers are required by law in many jurisdictions to make their towers visible to, for example, aircraft.

One method involves the use of both red and white LED lights. This methodology is commonplace, for example, in the context of FM transmission towers.

One method is to paint the tower for daytime visibility and provide red LED lights for nighttime visibility. This method is commonplace in the context of AM towers.

### SUMMARY OF THE DISCLOSURE

Forming one aspect of the invention is an improved system for lighting a tower, the system being of the type including red LED lights on the tower, a white LED light on the beacon, a photocell, a controller operatively coupled to the lights and photocell to operate the lights responsive to the photocell and an RF choke interposed between the beacon light and the controller to isolate the controller from the RF energy on the tower, the improvement comprising: a further RF choke interposed between (i) the input power and the controller and (ii) between the photocell and the controller.

According to another aspect of the invention, the improved system can be used for illuminating an AM transmission tower.

Forming yet another aspect of the invention is a system for use with an AM transmission tower and an ATU building, the system comprising: a red LED double obstruction light mounted in use on the tower; a photocell remotely mounted (otherwise than on the tower); a white LED beacon mounted in use on the tower; in the ATU building, a controller; an RF choke interposed between and operatively coupling the beacon and the controller; and an RF choke interposed between and operatively coupling the photocell and the controller.

According to a further aspect of the invention, in the system, the RF choke interposed between and operatively coupling the photocell and the controller is also interposed between and operatively coupling the controller and controller input power; and interposed between and operatively coupling the double obstruction light and the controller.

According to a yet further aspect of the invention, in the system, a double obstruction light RF choke is interposed between the double obstruction light and the RF choke interposed between the photocell and the controller.

Advantages, features and characteristics of the invention will become apparent upon a review of the detailed description and the appended drawing, the latter being briefly described hereinbelow.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a schematic view of a system according to an exemplary embodiment of the invention in use with an AM transmission tower and an ATU building.

### DETAILED DESCRIPTION

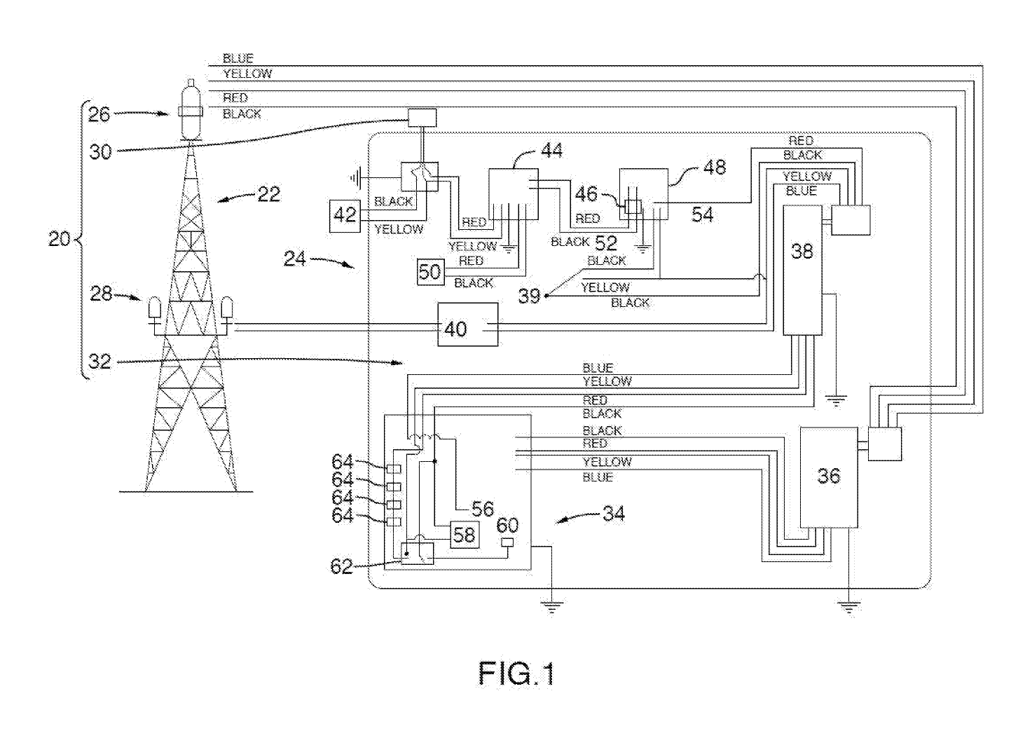

Reference is made to FIG. 1 which shows an AM transmission tower, indicated with general reference numeral 22, and an outlined area 24, which is representative of an ATU Building.

The system of the exemplary embodiment is indicated by general reference 20 and will be seen to be disposed largely interiorly of the ATU building 24 and to include on the tower 22, a beacon 26 and a double obstruction light 28, the latter being defined by red light emitting diodes and former being defined by white light emitting diodes; a photocell 30; and circuitry 32 disposed interiorly of the ATU building. The circuitry 32 includes: a controller 34; an RF choke 36 interposed between and operatively coupling the beacon 26 and the controller 34; an RF choke 38 interposed between and operatively coupling: (i) the photocell 30 and the controller 34, (ii) the controller 34 and controller input power 39 (120 VAC); (iii) the double obstruction light 28 and the controller 34; and (iv) a double obstruction light RF choke 40 interposed between the double obstruction light 28 and RF choke 38.

Various other component parts are labeled for comprehensiveness:
42 120 VAC power
44 120 VAC, 24 VDC relay
46 ferrite
48 ATU building relay box
50 24V DC supply
52 24V DC
54 input load 120 VAC to input choke
56 marker out
58 120V input
60 PEC load in
62 relay
64 ferrites

TEK cable is denoted by color in the drawings, for, inter alia, ease of installation.

Surprisingly, it has been found that the aforedescribed system provides a red-and-white LED lighting system suitable for 50,000 Watt AM antenna towers that is relatively robust in operation, thereby avoiding the need for periodic tower painting.

Whereas a single embodiment is herein shown and described, variations are possible. Accordingly, the invention should be understood to be limited only by the accompanying claims, purposively construed.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. An improved system for lighting a tower, the system being of the type including red LED lights on the tower, a white LED light on the beacon, a photocell, a controller operatively coupled to the lights and photocell to operate the lights responsive to the photocell and an RF choke interposed between the beacon light and the controller to isolate the controller from the RF energy on the tower, the improvement comprising:
a further RF choke interposed between (i) the input power and the controller and (ii) between the photocell and the controller.

2. A system for use with an AM transmission tower and an ATU building, the system comprising:
a red LED double obstruction light mounted in use on the tower;
a photocell;
a white LED beacon mounted in use on the tower;
in the ATU building, a controller;
an RF choke interposed between and operatively coupling the beacon and the controller; and
an RF choke interposed between and operatively coupling the photocell and the controller.

3. The system of claim 2, wherein the RF choke interposed between and operatively coupling the photocell and the controller is also
interposed between and operatively coupling the controller and controller input power; and
interposed between and operatively coupling the double obstruction light and the controller.

4. The system of claim 2 or 3, wherein a double obstruction light RF choke is interposed between
the double obstruction light; and
the RF choke interposed between the photocell and the controller.

5. Use of the improved system of claim 1 for illuminating an AM transmission tower.
